(19) United States
(12) Patent Application Publication
(10) Pub. No.: US 2013/0235011 A1
(43) Pub. Date: Sep. 12, 2013

(54) LCD Panel Driving Method, Display Drive Circuit, and LCD Device

(71) Applicants: Poshen Lin, Shenzhen (CN); Xiaoping Tan, Shenzhen (CN)

(72) Inventors: Poshen Lin, Shenzhen (CN); Xiaoping Tan, Shenzhen (CN)

(21) Appl. No.: 13/503,851

(22) PCT Filed: Mar. 15, 2012
(86) PCT No.: PCT/CN12/72355

§ 371 Date: Apr. 24, 2012

(30) Foreign Application Priority Data
Mar. 6, 2012 (CN) 201210056874.X

(51) Int. Cl. G09G 5/00; G09G 3/36

(52) U.S. Cl. 345/211; 345/87

(57) ABSTRACT

The invention provides a method for driving an LCD panel, a display drive circuit, and an LCD device. The method for driving an LCD panel includes the following steps: A: obtaining a coordinate position of a pixel to be displayed on a current frame of the LCD panel and a ideal voltage required by the correspondingly displayed gray scale corresponding thereto; B: determining a compensating voltage for improving the uniformity of the LCD panel in accordance with the coordinate position of the current pixel on the LCD panel, and loading the compensating voltage onto the corresponding data line. The invention has the advantages that the charge time difference of all areas of the LCD panel caused by the charge resulting from waveform delay variation because of resistor and capacitor (RC delay) is improved, the display uniformity of LCD panels, in particular large LCD panels is improved, and the taste thereof is increased.

### TECHNICAL FIELD

The invention relates to the field of liquid crystal displays (LCDs), and more particularly to a method for driving an LCD panel, a display drive circuit, and an LCD device.

### BACKGROUND

The resolution and size of conventional LCDs are increasingly large. As shown in FIG. 1, the load of the equivalent resistor and capacitor of the equivalent transmission path corresponding to a panel mainly driven by thin film transistors (TFTs) becomes larger, as shown in FIG. 2, causing both the data signals output by data drive circuits and the gate control signals output by gate drive circuits to be varied, which is usually called RC delay by those skilled in the art. As shown in FIG. 3, when the resolution and the size are increased, the RC delay is increased, and the variation is worsened. Take a double-side gate drive circuit and a single-side data drive circuit for example, the gate control signals in the middle part have the most serious variation, and the data signals at the lower end have the most serious variation. Thus, there is a large difference between the uniformity of the center and that of the periphery, resulting in poor images.

### SUMMARY

In view of the above-described problems, the aim of the invention is to provide a method for driving an LCD panel, a display drive circuit, and an LCD device capable of improving the display uniformity of the LCD panel.

The aim of the invention is achieved by the following technical schemes.

A method for driving an LCD panel comprises the following steps:

A: Obtaining a coordinate position of a pixel to be displayed on a current frame of an LCD panel and an ideal voltage required by the gray scale displayed correspondingly thereto; and

B: Determining a compensating voltage for improving the uniformity of the LCD panel in accordance with the coordinate position of the pixel on the LCD panel, and loading the compensating voltage onto a corresponding data line.

Preferably, the step B comprises: determining a compensation weight for improving the uniformity of the LCD panel in accordance with the currently displayed coordinate position, and multiplying the ideal voltage and the compensation weight to calculate the compensating voltage value for improving the uniformity of the LCD panel. This is a specific method of calculating the compensating voltage.

Preferably, the step A further comprises: reading a drive voltage of the pixel to be displayed on a previous frame; the step B further comprises: comparing voltage difference between the voltage of the pixel to be displayed on the previous frame and the currently required voltage; determining a response voltage for accelerating the response speed of liquid crystal molecules in accordance with the voltage difference; superimposing the response voltage and the compensating voltage; and loading the superimposed voltage onto the corresponding data line. Because the turn-on time of each TFT is short, certain time is required for the deflection of the liquid crystal molecules, and the corresponding TFT is closed before the arrival of liquid crystal molecules at the predetermined position. Thus, the expected displayed gray scale is not achieved. Therefore, the display quality can be further improved by superimposing the response voltage when compensating RC delay. Generally, the deflection speed of the liquid crystal molecules has a direct relationship with the voltage difference; the more the voltage difference is, the quicker the deflection speed is. Therefore, it is necessary to compare the voltage difference between the currently required drive voltage and the drive voltage of the previous frame, to determine the actual compensating voltage value in accordance with the voltage difference.

Preferably, in the step A, the coordinate position displayed on the current frame is stored into a frame buffer in advance, and a voltage compensation module reads the data of the frame buffer to obtain the coordinate position of the current frame to be displayed on the LCD panel. The current display frame is stored into the frame buffer in advance. Thus, the voltage compensation module only needs to read the data of the frame buffer, to determine the currently displayed coordinate position, and lookup table to output the compensating voltage. The compensating voltage of each coordinate position can be calculated by the pre-stored frame data in accordance with the frame data in advance, thereby improving the calculating speed.

A display drive circuit of an LCD panel comprises data line(s), data drive circuit(s) connected with the data line; wherein a voltage compensation module which is determined in accordance with the currently displayed coordinate position and used for improving the uniformity of the LCD panel is arranged between the data line and the data drive circuit.

Preferably, the voltage compensation module is internally integrated with a table unit for storing the pixel of each coordinate position and a compensation weight corresponding thereto. This is a specific voltage compensation structure. The actual compensating voltage can be obtained by multiplying the ideal voltage and the corresponding compensation weight.

Preferably, a response compensation module for accelerating the response speed of liquid crystal molecules is arranged between the data line and the data drive circuit. Because the turn-on time of each TFT is short, certain time is required for the deflection of liquid crystal molecules, and the corresponding TFT is closed before the arrival of liquid crystal molecules at the predetermined position. Thus, the expected displayed gray scale is not achieved. Therefore, the display quality can be further improved by superimposing the compensating voltage when compensating RC delay. Generally, the deflection speed of the liquid crystal molecules has a direct relationship with the voltage difference; the more the voltage difference is, the quicker the deflection speed is. Therefore, it is necessary to compare the voltage difference between the currently required drive voltage and the drive voltage of the previous frame, to determine the actual compensating voltage value in accordance with the voltage difference.

Preferably, the display drive circuit of the LCD panel further comprises a frame buffer; the voltage compensation module is connected with the frame buffer. The current display frame is stored into the frame buffer in advance. Thus, the voltage compensation module only needs to read the data of the frame buffer, to determine the currently displayed coordinate position, and lookup table to output the compensating voltage. The compensating voltage of each coordinate position can be calculated by the pre-stored frame data in accordance with the frame data in advance, thereby improving the response speed of the drive.

Preferably, both ends of the scan line are separately provided with a gate drive circuit, the highest compensating voltage is output by the voltage compensation module in the middle of the display area, and the value of the compensating voltage is decreased progressively to the two ends. This is a display drive circuit of a dual-gate drive circuit. The inventor finds that the dual-gate drive circuit has the most serious delay variation in the middle part, and has gradually slight delay variation to both ends. Therefore, the scan line in the middle part has the highest compensating voltage, and has progressively decreased compensating voltage to both ends.

Preferably, one end of the data line is provided with a data drive circuit, and the voltage compensation module is arranged between the data line and the data drive circuit. This is a drive compensation scheme of the data line of a single-data drive circuit

Preferably, the voltage compensation module is provided with a minimum compensating voltage when driving a pixel electrode of the LCD panel closest to the output end thereof, and the value of the compensating voltage is increased progressively along with the increase of distance. The inventor finds that the farther the data line from the signal output end is, the more serious the variation is, and the higher the required compensating voltage is.

Preferably, voltage compensation modules are respectively arranged between the data lines and the data drive circuits; both ends of the scan line are separately provided with a gate drive circuit, the highest compensating voltage is output by the voltage compensation module in the middle of the display area of the LCD panel, and the value of the compensating voltage is decreased progressively to the two ends; one end of the data line is provided with a data drive circuit, the voltage compensation module is provided with a minimum compensating voltage when driving the pixel electrode of the LCD panel closest to the output end thereof, and the value the compensating voltage is increased progressively along with the increase of distance. This is an example of a dual-gate single-data drive circuit.

An LCD device comprises the aforementioned display drive circuit of the LCD panel.

By adding the voltage compensation module(s) on the display drive circuit of the LCD panel of the invention, the required compensating voltage is calculated in accordance with the currently displayed coordinate position, and then the corresponding scan line or data line is driven to compensate voltage, so that the display luminance of the whole LCD panel is uniform, thereby improving the charge time difference of all areas of the LCD panel caused by the charge resulting from waveform delay variation because of the resistor and the capacitor (RC delay), improving the display uniformity of LCD panels, in particular large LCD panels, and increasing the taste thereof.

### BRIEF DESCRIPTION OF FIGURES

FIG. 1 is a schematic diagram of an LCD panel;

FIG. 2 is a schematic diagram of a display drive circuit of an LCD panel;

FIG. 3 is a waveform diagram of a RC delay of a display drive circuit of an existing LCD panel;

FIG. 4 is a functional block diagram of the invention;

FIG. 5 is a waveform diagram improved by the invention; and

FIG. 6 is a flow diagram of a method of the invention.

Wherein: 100. TFT; 110. LCD capacitor; 120. storage capacitor; 200. gate drive circuit; 300. data drive circuit; 400. compensating voltage drive; 500. variation waveform of data line; 600. variation waveform of scan line; 700. waveform of compensating voltage.

### DETAILED DESCRIPTION

The invention will be further described in accordance with the figures and the preferred examples.

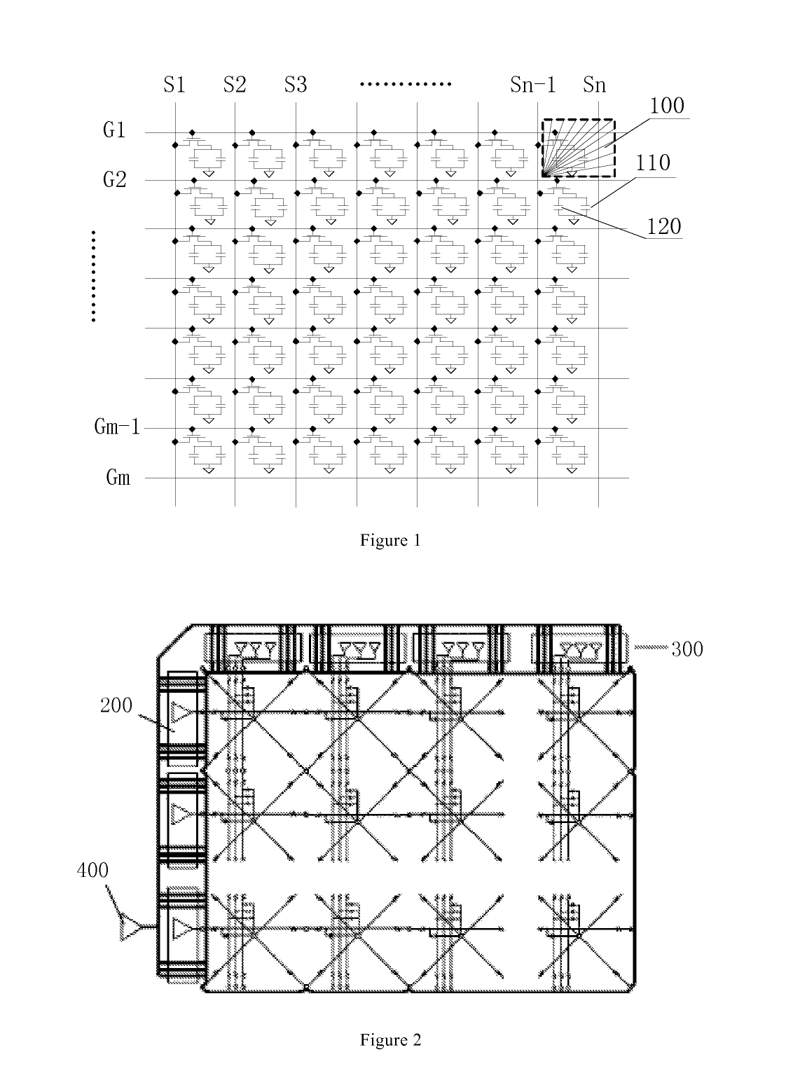

An LCD device comprises an LCD panel. As shown in FIG. 1, the LCD panel comprises scan lines and data lines which are crisscross arranged; G1Gm−1 are scan lines, and S1-Sn are data lines. A thin film transistor (TFT) 100 is arranged in a matrix formed by the scan lines and the data lines. A source electrode of the TFT is connected with the data line, a gate electrode of the TFT is connected with the scan line, and an LCD capacitor 110 and a memory capacitor 120 which are arranged in parallel are connected between a drain electrode of the TFT and a common electrode. The LCD panel of the invention comprises a display drive circuit; the display drive circuit comprises scan line(s), data line(s), gate drive circuit(s) 200 connected with the scan line, and data drive circuit(s) 300 connected with the data line. A voltage compensation module which is determined in accordance with the currently displayed coordinate position and used for improving the uniformity of the LCD panel is arranged between the data line and the data drive circuit; the voltage compensation module is internally integrated with a table unit for storing the pixel of each coordinate position and a compensation weight corresponding thereto. The circuit generating the compensating voltage can be integrated with the table unit, and can provide drive voltage via externally expanding the compensating voltage drive 400 (as shown in FIG. 2). The conception of the invention will be further described in detail using a dual-gate single-data drive circuit as examples.

Voltage compensation modules are respectively arranged between the data lines and the data drive circuits 300; both ends of the scan line are separately provided with a gate drive circuit 200, the highest compensating voltage is output by the voltage compensation module in the middle of the display area of the LCD panel, and the value of the compensating voltage is decreased progressively to the two ends; one end of the data line is provided with a data drive circuit 300, the voltage compensation module is provided with a minimum compensating voltage when driving the pixel electrode of the LCD panel closest to the output end thereof, and the value of the compensating voltage is increased progressively along with the increase of distance. In accordance with the aforementioned rule, the RC delay of different pixels in different coordinate positions is determined in accordance with the physical characteristics of material and circuit arrangement and the like in the process of manufacturing LCD panels, and the compensating voltage of each coordinate position is calculated in accordance with different RC delay and then is loaded onto the corresponding data line during display. Specifically, the compensation weight of each coordinate position is calculated in accordance with different RC delay, and then is stored into the table unit. When the LCD panel displays, before driving the pixel of the data line in a certain coordinate position, the voltage compensation module reads the compensation weight of the corresponding coordinate position from the table unit, and then calculates the compensating voltage value and outputs the calculated compensating voltage to the corresponding data line.

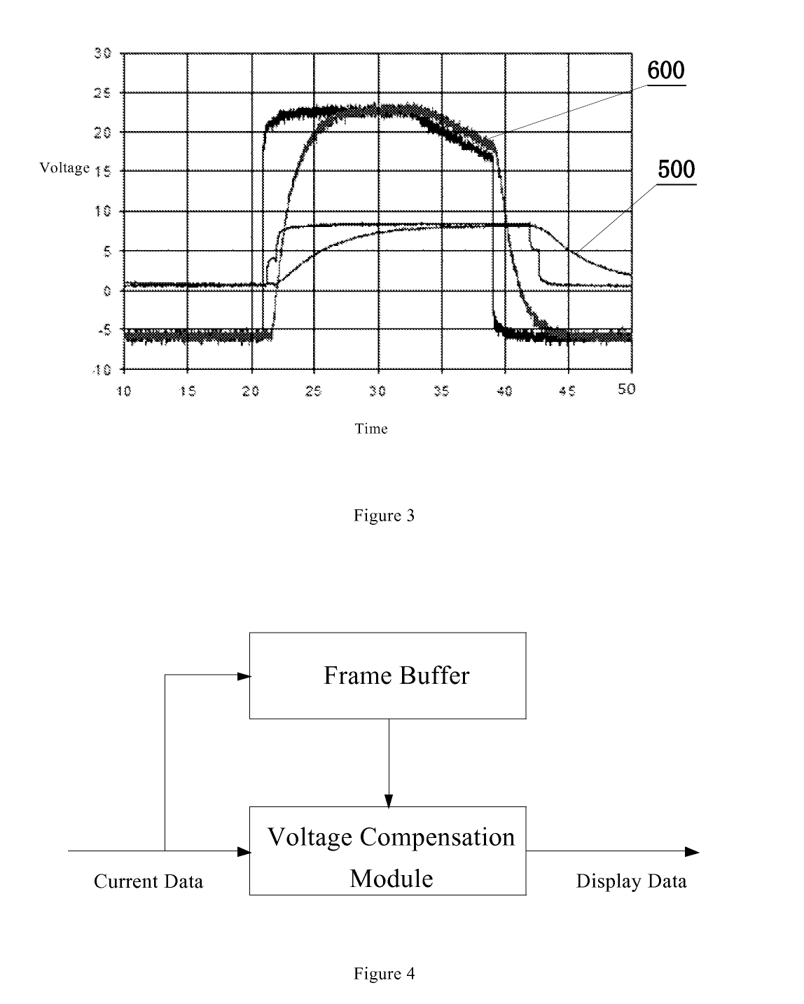

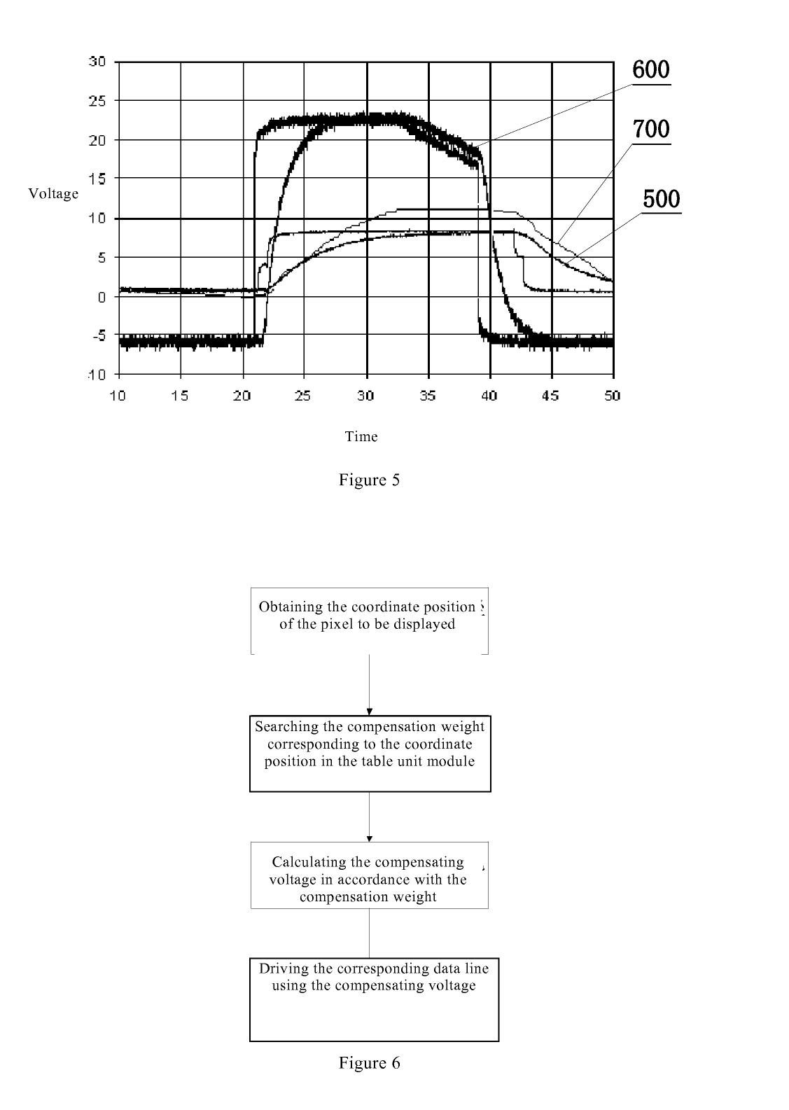

As shown in FIG. 4, a frame buffer is arranged on the LCD panel. The voltage compensation module is connected with the frame buffer. In use, the current display frame is stored into the frame buffer in advance. Thus, the voltage compensation module only needs to read the data of the frame buffer, to determine the currently displayed coordinate position, and lookup table to output the compensating voltage. The compensating voltage value of each coordinate position can be calculated by the pre-stored frame data in accordance with the frame data in advance, thereby improving the response speed of the drive. A timing control circuit (T-con) receives data, in accordance with the coordinate position of one current frame to be displayed by the T-con, such as the (960,540) position with the resolution of 1920×1080, both the data line and the scan line are varied, causing all the areas of the panel to have different charge time and charging degree, and then having nonuniform luminance. The corresponding compensating voltage sent from the current position is detected using the voltage compensation module to enable the charging degree of all the areas to be consistent, so as to increase the uniformity. As shown in FIG. 5, the charging degree of the central area is consistent with that of the initial end as possibly by compensating the central area (drive of double sides) or one end (drive of one side).

Because the turn-on time of each TFT is short, certain time is required for the deflection of liquid crystal molecules, and the corresponding TFT is closed before the arrival of liquid crystal molecules at the predetermined position. Thus, the expected displayed gray scale is not achieved. Therefore, a response compensation module for accelerating the response speed of liquid crystal molecules can be arranged between the data line and the data drive circuit. Generally, the deflection speed of the liquid crystal molecules has a direct relationship with the voltage difference, the more the voltage difference is, the quicker the deflection speed is. Therefore, it is necessary to compare the voltage difference between the currently required drive voltage and the drive voltage of the previous frame, to determine the actual compensating voltage value in accordance with the voltage difference. The response compensation module can be used together with the voltage compensation module. When the two are used together, it is necessary to comprehensively consider the physical characteristics of different LCD panels and the voltage difference between the drive voltage of the pixel on the previous frame and the drive voltage required on the current frame, to calculate the actual output voltage. Thus, the deflection speed of the liquid crystal molecules is increased when compensating RC delay, and the display quality is further improved.

The aforementioned driving method comprises the following steps:

A: Obtaining the coordinate position of the pixel to be displayed on the current frame of the LCD panel and the ideal voltage required by the correspondingly displayed gray scale thereto; and

B: Determining the compensating voltage for improving the uniformity of the LCD panel in accordance with the coordinate position of the current pixel on the LCD panel, and loading the compensating voltage onto the corresponding data line.

Further, as shown in FIG. 6, in the step B, the compensation weight for improving the uniformity of the LCD panel is determined in accordance with the currently displayed coordinate position, and the ideal voltage is multiplied by the compensation weight to calculate the compensating voltage for improving the uniformity of the LCD panel.

To improve the deflection speed of the liquid crystal molecules, the step A further comprises: reading the drive voltage of the current coordinate position to be displayed on the previous frame; the step B further comprises: comparing the voltage of the pixel to be displayed on the previous frame with the currently required voltage in the currently displayed position; determining the compensating voltage; superimposing the compensating voltage into the actual voltage; and loading the superimposed voltage onto the corresponding data line. Because the turn-on time of each TFT is short, certain time is required for the deflection of liquid crystal molecules, and the corresponding TFT is closed before the arrival of liquid crystal molecules at the predetermined position. Thus, the expected displayed gray scale is not achieved. Therefore, the display quality can be further improved by superimposing compensating voltage when compensating RC delay. Generally, the deflection speed of liquid crystal molecules has a direct relationship with the voltage difference; the more the voltage difference is, the quicker the deflection speed is. Therefore, it is necessary to compare the voltage difference between the currently required drive voltage and the drive voltage of the previous frame, to determine the actual compensating voltage value in accordance with the voltage difference. An over-voltage module can be integrated into the voltage compensation module, and can be singly arranged.

The coordinate position displayed on the current frame is stored into the frame buffer in advance, and the voltage compensation module reads the data of the frame buffer to obtain the coordinate position of the current frame to be displayed on the LCD panel. The current display frame is stored into the frame buffer in advance. Thus, the voltage compensation module only needs to read the data of the frame buffer, to determine the currently displayed coordinate position, and lookup table to output the compensating voltage. The compensating voltage of each coordinate position can be calculated via the pre-stored frame data in accordance with the frame data in advance, thereby, improving the response speed of the drive; of course, the voltage compensation module can directly read the currently displayed coordinate position from the display signal in real time, and then calculate the compensating voltage value.

For the dual-gate single-data drive circuit, because both ends of the scan line are separately provided with a drive, the data signal has the most serious delay variation in the middle part, and has gradually slight variation to both ends. Therefore, the voltage compensation module is provided with the highest output compensating voltage in the middle of the display area of the LCD panel, and the value of the compensating voltage is progressively decreased to the two ends. Similarly, the farther the data signal from signal output end of the data line is, the more serious the variation is. Therefore, the voltage compensation module is provided with a minimum compensating voltage when driving the pixel electrode of the LCD panel closest to the output end thereof, and the value of the compensating voltage is increased progressively along with the increase of distance.

The invention is described in detail in accordance with the above contents with the dual-gate single-data drive circuit. The technical scheme is suitable for the single-gate single-data line or the single-gate dual-data drive circuit. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A method for driving an LCD panel, comprising the following steps:
A: obtaining a coordinate position of a pixel to be displayed on a current frame of the LCD panel and an ideal voltage value required by a correspondingly displayed gray scale thereto; and
B: determining a compensating voltage for improving the uniformity of the LCD panel in accordance with the coordinate position of the pixel on the LCD panel, and then loading the compensating voltage onto a corresponding data line.

2. The method for driving an LCD panel of claim 1, wherein in said step A, the coordinate position displayed on the current frame is stored into a frame buffer in advance, and a voltage compensation module reads the data of the frame buffer to obtain the coordinate position of the current frame to be displayed on the LCD panel.

3. The method for driving an LCD panel of claim 1, wherein in said step B, a compensation weight for improving the uniformity of the LCD panel is determined in accordance with the currently displayed coordinate position, and the ideal voltage is multiplied by the compensation weight to calculate the compensating voltage for improving the uniformity of the LCD panel.

4. The method for driving an LCD panel of claim 3, wherein in said step A, the coordinate position displayed on the current frame is stored into the frame buffer in advance, and the voltage compensation module reads the data of the frame buffer to obtain the coordinate position of the current frame to be displayed on the LCD panel.

5. The method for driving an LCD panel of claim 1, wherein said step A further comprises: reading a drive voltage of the pixel to be displayed on a previous frame; said step B further comprises: comparing voltage difference between a voltage of the pixel to be displayed on a previous frame and a currently required voltage; determining a response voltage for accelerating the response speed of liquid crystal molecules in accordance with the voltage difference; superimposing said response voltage and said compensating voltage; and loading the superimposed voltage onto the corresponding data line.

6. The method for driving an LCD panel of claim 5, wherein in said step A, the coordinate position displayed on the current frame is stored into the frame buffer in advance, and the voltage compensation module reads the data of the frame buffer to obtain the coordinate position of the current frame to be displayed on the LCD panel.

7. A display drive circuit for an LCD panel, comprising: data line(s), data drive circuit(s) connected with said data line; wherein a voltage compensation module determined in accordance with a currently displayed coordinate position for improving the uniformity of the LCD panel is arranged between said data line and said data drive circuit.

8. The display drive circuit for the LCD panel of claim 7, wherein said voltage compensation module is internally integrated with a table unit for storing the pixel of each coordinate position and a compensation weight corresponding thereto.

9. The display drive circuit for the LCD panel of claim 7, wherein a response compensation module for accelerating the response speed of liquid crystal molecules is arranged between said data line and said data drive circuit.

10. The display drive circuit for the LCD panel of claim 7, wherein said display drive circuit for an LCD panel further comprises a frame buffer; said voltage compensation module is connected with said frame buffer.

11. The display drive circuit for the LCD panel of claim 7, wherein both ends of said scan line are separately provided with a gate drive circuit, the highest compensating voltage is output by said voltage compensation module in the middle of the display area of the LCD panel, and the value of the compensating voltage is decreased progressively to the two ends.

12. The display drive circuit for the LCD panel of claim 7, wherein one end of said data line is provided with a data drive circuit, and said voltage compensation module is arranged between said data line and said data drive circuit.

13. The display drive circuit for the LCD panel of claim 12, wherein, said voltage compensation module is provided with a minimum compensating voltage when driving a pixel electrode of the LCD panel closest to the output end thereof, and the value of the compensating voltage is increased progressively along with the increase of distance.

14. The display drive circuit for the LCD panel of claim 7, wherein a voltage compensation module is arranged between said data line and said data drive circuit; both ends of said scan line are separately provided with a gate drive circuit, the highest compensating voltage is output by said voltage compensation module in the middle of the display area of the LCD panel, and the value of the compensating voltage is decreased progressively to the two ends; one end of said data line is provided with a data drive circuit, said voltage compensation module is provided with a minimum compensating voltage when driving a pixel electrode of the LCD panel closest to the output end thereof, and the value of the compensating voltage is increased progressively along with the increase of distance.

15. An LCD device, comprising: a display drive circuit for an LCD panel; wherein said display drive circuit for the LCD panel comprises data line(s), data drive circuit(s) connected with said data line; a voltage compensation module determined in accordance with the currently displayed coordinate position for improving the uniformity of the LCD panel is arranged between said data line and said data drive circuit.

16. The LCD device of claim 15, wherein said voltage compensation module is internally integrated with a table unit for storing the pixel of each coordinate position and a compensation weight corresponding thereto.

17. The LCD device of claim 15, wherein a response compensation module for accelerating the response speed of liquid crystal molecules is arranged between said data line and said data drive circuit.

18. The LCD device of claim 15, wherein the display drive circuit for the LCD panel further comprises a frame buffer; said voltage compensation module is connected with said frame buffer.

19. The LCD device of claim 15, wherein one end of said data line is provided with a data drive circuit, and said voltage compensation module is arranged between said data line and said data drive circuit; said voltage compensation module is provided with a minimum compensating voltage when driving a pixel electrode of the LCD panel closest to the output end thereof, and the value of the compensating voltage is increased progressively along with the increase of distance.

20. The LCD device of claim 15, wherein a voltage compensation module is arranged between said data line and said data drive circuit; both ends of said scan line are separately provided with a gate drive circuit, the highest compensating voltage is output by said voltage compensation module in the middle of the display area of the LCD panel, and the value of the compensating voltage is decreased progressively to the two ends; one end of said data line is provided with a data drive circuit, said voltage compensation module is provided with a minimum compensating voltage when driving the pixel electrode of the LCD panel closest to the output end thereof, and the value of the compensating voltage is increased progressively along with the increase of distance.
